(19) United States
(12) Patent Application Publication
(10) Pub. No.: US 2017/0310724 A1
(43) Pub. Date: Oct. 26, 2017

(54) SYSTEM AND METHOD OF PROCESSING MEDIA DATA

(71) Applicant: HON HAI PRECISION INDUSTRY CO., LTD., New Taipei (TW)

(72) Inventors: SHU-LUN CHANG, New Taipei (TW); YEN-YI LIN, New Taipei (TW)

(21) Appl. No.: 15/470,897

(22) Filed: Mar. 27, 2017

(30) Foreign Application Priority Data
Apr. 26, 2016 (TW) 105112934

(51) Int. Cl. H04L 29/06; H04L 29/12

(52) U.S. Cl. CPC H04L 65/60; H04L 65/605; H04L 61/1594; H04L 65/4069

(57) ABSTRACT

A method for processing media data includes determining at least one target feature and determining corresponding effect relating to the at least one target feature. Media data is received from a sender. Once the at least one target feature is detected in the media data, the corresponding effect relating to the at least one target feature is applied to the media data.

### CROSS-REFERENCE TO RELATED APPLICATIONS

This application claims priority to Taiwanese Patent Application No. 105112934 filed on Apr. 26, 2016, the contents of which are incorporated by reference herein.

### FIELD

The subject matter herein generally relates to file processing technology and particularly to a system and a method for processing media data.

### BACKGROUND

Generally, when an electronic device such as a mobile phone processes a media file, the electronic device needs to completely load the media file before identifying a static object from the media file. The electronic device then adds a customized static object into the media file according to the identified static object. However, under this processing methodology, the electronic device needs to load the media file completely before identifying the static object. Furthermore, the object identified from the media file or added into the media file is typically a static object.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a schematic diagram illustrating one exemplary embodiment of a server communicating with a sender and a receiver.

FIG. 2 is a block diagram illustrating one exemplary embodiment of modules of a media data processing system included in the server of FIG. 1.

FIG. 3 is a flowchart illustrating one exemplary embodiment of a method for processing media data.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

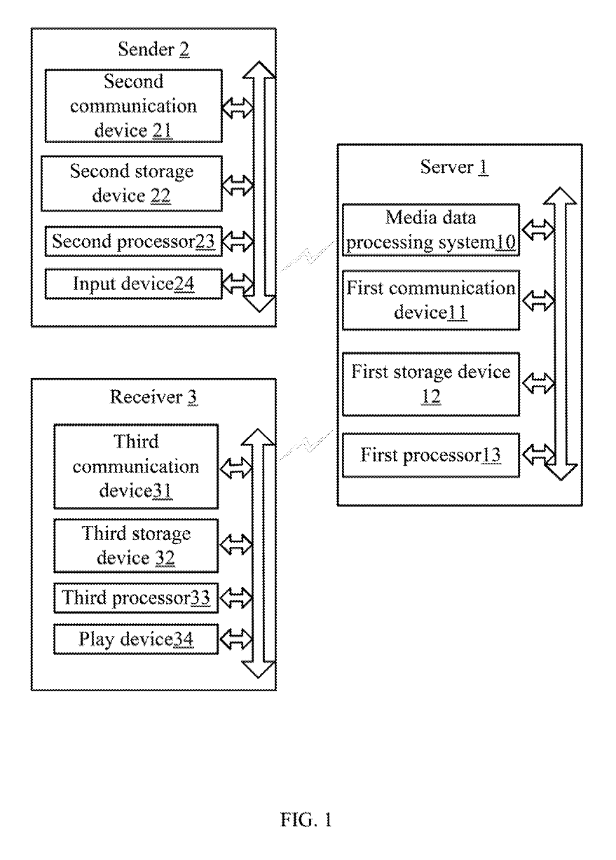

FIG. 1 is a block diagram illustrating one exemplary embodiment of a server including a media data processing system. In at least one exemplary embodiment, a server 1 can communicate with a sender 2 and at least one receiver 3. Depending on the embodiment, the server 1 can include, but is not limited to, a media data processing system 10, a first communication device 11, a first storage device 12, and at least one first processor 13. The first communication device 11, the first storage device 12, and the at least one first processor 13 can communicate with each other through a system bus. Depending on the embodiment, the sender 2 can include, but is not limited to, a second communication device 21, a second storage device 22, at least one second processor 23, and an input device 24. The second communication device 21, the second storage device 22, the at least one second processor 23, and the input device 24 can communicate with each other through a system bus. Depending on the embodiment, the receiver 3 can include, but is not limited to, a third communication device 31, a third storage device 32, at least one third processor 33, and a playback device 34. The third communication device 31, the third storage device 32, the at least one third processor 33, and the playback device 34 can communicate with each other through a system bus. FIG. 1 illustrates only one example of the server 1, the sender 2, and the receiver 3, that can include more or fewer components than illustrated, or have different configuration of various components in other embodiments.

In at least one exemplary embodiment, the server 1 can communicate with the sender 2 and the at least one receiver 3 through the first communication device 11, the second communication device 21, and the third communication device 31. The first communication device 11, the second communication device 21, and the third communication device 31 can be wired cards, wireless cards, or General Packet Radio Service (GPRS) modules. In at least one exemplary embodiment, the server 1, the sender 2, and the at least one receiver 3 can communicate with internet respectively through the first communication device 11, the second communication device 21, and the third communication device 31. Thus, the server 1, the sender 2 and the at least one receiver 3 can communicate with each other through the internet.

In at least one exemplary embodiment, the first storage device 12 can be a memory of the server 1, the second storage device 22 can be a memory of the sender 2, and the third storage device 32 can be a memory of the receiver 3. In other exemplary embodiments, the first storage device 12, the second storage device 22, and the third storage device 32 can be secure digital cards, or other external storage device such as smart media cards.

In at least one exemplary embodiment, the at least one first processor 13, the at least one second processor 23, and the at least one third processor 33 can be central processing units (CPU), microprocessors, or other data processor chips.

In at least one exemplary embodiment, the input device 24 can receive input of a user of sender 2. The input can include target features set by the user, and effect set for each of the target features by the user (hereinafter “corresponding effect relating to the target feature”). In other exemplary embodiments, the corresponding effect relating to the target feature can be a default setting. The input device 24 can also receive media data input by the user. In at least one exemplary embodiment, the input device 24 can be a touch screen, or a keyboard, and is not limited to the examples provided in the exemplary embodiment. In other exemplary embodiments, the input device 24 can further include a microphone and a camera that can be used to input audio data and video data. In at least one exemplary embodiment, the media data can be an audio file, a video file, or a combination of the audio file and the video file.

In at least one exemplary embodiment, the target features can include, but are not limited to, a predetermined facial expression (e.g., a smiling face, a crying face, or a grimace), a predetermined action (e.g., hands up, get down, or wipe the tears), predetermined sounds (e.g., laughter, or applause), and/or one or more predetermined objects (e.g., a glass, and/or a hat). In at least one exemplary embodiment, the media data processing system 10 stored in the first storage device 12 can detect the target features by invoking preset programs. The preset programs can be a facial expression recognition program, a speech recognition program, or an object recognition program.

In at least one exemplary embodiment, the corresponding effect relating to the target feature can be a playing of a preset audio file, a display of one or more predetermined pictures, a playing of a predetermined cartoon, and/or presenting of one or more special effects. For example, the presenting of one or more special effects can be a pair of virtual sunglasses is added on eyes of a face, or a virtual loudspeaker is added on a hand.

In at least one exemplary embodiment, the playback device 34 can play media data. The playback device 34 can be an audio device, a media file device, or a device including both. For example, the audio device can be a loudspeaker. The playback device 34 can further include a display screen.

In at least one exemplary embodiment, the sender 2 can send the server 1 media data that need to be processed by the server 1. The sender 2 can further send an address list to the server 1. The address list lists at least one receiver 3 for receiving the media data that has been processed by the server 1. The receiver 3 can receive the processed media data from the server 1, and can playback the processed media data. In at least one exemplary embodiment, each of the sender 2 and the receiver 3 can be a mobile phone, a tablet computer, a personal digital assistant, a wearable device, or any other suitable device. In at least one exemplary embodiment, the server 1 can be a computer, a server, or any other similar device that can remotely communicate with the sender 2 and the receiver 2.

In at least one exemplary embodiment, the sender 2 can also act as the receiver 3. For example, after the sender 2 send the media data to the server 1 for processing, the sender 2 can also receive the processed media data from the server 1 by adding the sender 2 into the address list. In other words, the sender 2 and the receiver 3 can be a same device.

In at least one exemplary embodiment, the media data processing system 10 can receive from the sender 2 media data needing to be processed and the target features. The media data processing system 10 can immediately detect the target feature from the media data when the target features are received. The media data processing system 10 can apply the corresponding effect relating to the detected target features to the media data.

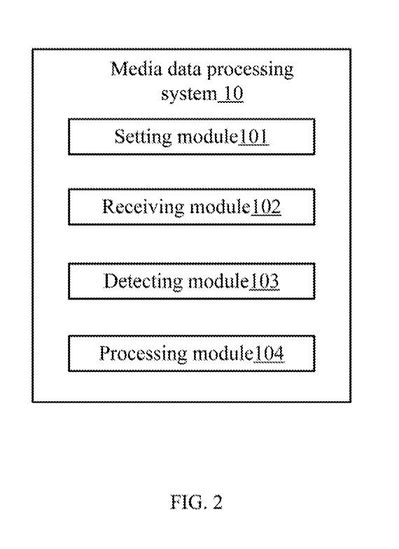

In at least one exemplary embodiment, the media data processing system 10 can include a setting module 101, a receiving module 102, a detecting module 103, and a processing module 104 as shown in FIG. 2. The modules 101-104 include computerized codes in the form of one or more programs that may be stored in the first storage device 12. The computerized codes include instructions that are executed by the at least one first processor 13.

In at least one exemplary embodiment, the setting module 101 can determine at least one target feature. The setting module 101 can further determine the corresponding effect relating to the at least one target feature.

In at least one exemplary embodiment, the setting module 101 can send the sender 2 all target features that generally may be included in media data through the first communication device 11. The setting module 101 further can send the corresponding effect relating to each of the target features. The sender 2 can receive all the target features and the corresponding effect relating to each of the target features from the setting module 101 through the second communication device 21. The sender 2 further can display all the target features and the corresponding effect relating to each of the target features for a user of the sender 2. Thus, the user of the sender 2 can select the at least one target feature and the corresponding effect through the input device 24. The sender 2 can transmit the at least one target feature and the corresponding effect to the server 1 through the second communication device 21, thus, the setting module 101 can determine the at least one target feature and the corresponding effect when the server 1 receives the at least one target feature and the corresponding effect from the sender 2. For example, the at least one target feature can be one spoken word and the corresponding effect can be the playing of the cartoon.

In other exemplary embodiments, the at least one target feature and the corresponding effect are default settings. For example, the at least one target feature and the corresponding effect can be preset when the media data processing system 10 is developed.

The receiving module 102 can receive media data and the address list from the sender 2. The address list lists at least one receiver 3 for receiving media data that has been processed by the server 1. In at least one exemplary embodiment, the media data can be an audio file (e.g., a recording), a video file (e.g., a video file recorded by the sender 2), a voice stream (e.g., a recording of dialing a call), or a video stream. In at least one exemplary embodiment, the sender 2 can send the media data to the server 1 in the form of file streaming.

The detecting module 103 can immediately detect the at least one target feature in the media data received from the sender 2 once the media data is received by the receiving module 102. In at least one exemplary embodiment, the detecting module 103 can detect the at least one target feature by invoking the preset programs. As mentioned above, the preset programs can be the facial expression recognition program, the speech recognition program, or the object recognition program. For example, when the at least one target feature is the smiling face, the detecting module 103 can detect the smiling face by invoking the facial expression recognition program. In at least one exemplary embodiment, when more than one target features need to be detected (i.e., the setting module 101 determines more than one target features) and one of the more than one target features is detected in the media data by the detecting module 103, the processing module 104 is immediately triggered. The detecting module 103 continues to detect other target features of the more than one target features in the media data, when one of the other target features is detected by the detecting module 103, the processing module 104 is executed. Similarly to the above steps, the detecting module can detect all of the more than one target features.

When the at least one target feature is detected in the media data, the processing module 104 can acquire the corresponding effect relating to the at least one target feature. The processing module 104 can apply the corresponding effect to the media data, thus media data is processed. In at least one exemplary embodiment, the processing module 104 can apply the corresponding effect to the media data using a predetermined program. The predetermined program can be a video renderer.

The processing module 104 can send the processed media data to the at least one receiver 3 according to the address list. In least one exemplary embodiment, the processing module 104 can further control the playback device 34 of the receiver 3 to playback the processed media data. In other exemplary embodiments, when the receiver 3 receives the processed media data, the receiver 3 controls the playback device 34 to playback the processed media data.

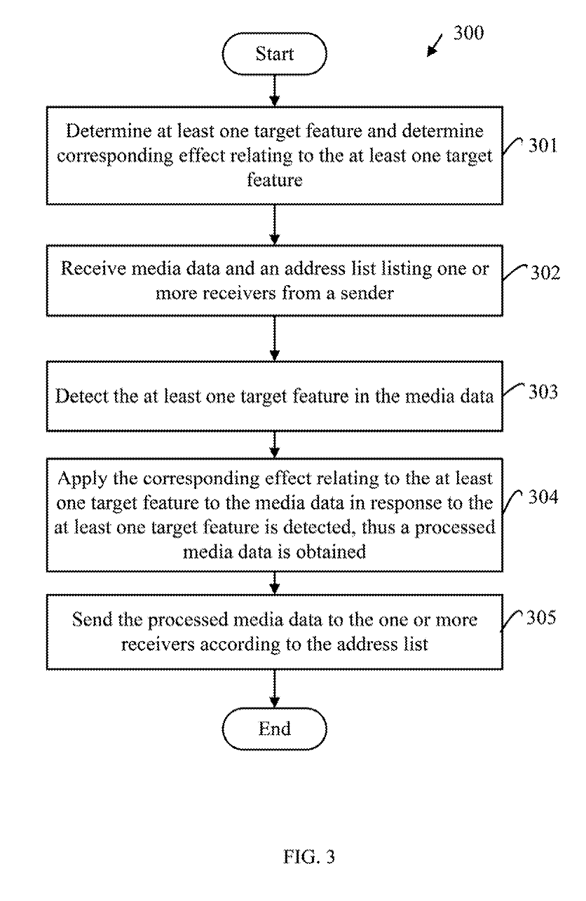

FIG. 3 illustrates a flowchart in accordance with an exemplary embodiment. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 3 represents one or more processes, methods, or subroutines, carried out in the example method 300. Additionally, the illustrated order of blocks is by example only and the order of the blocks can be changed according to the present disclosure. The example method 300 can begin at block 31. Depending on the embodiment, additional steps can be added, others removed, and the ordering of the steps can be changed.

At block 301, the setting module 101 can determine at least one target feature that needs to be detected. The setting module 101 can further determine the corresponding effect relating to the at least one target feature.

In at least one exemplary embodiment, the setting module 101 can send the sender 2 all of target features that generally may be included in media data through the first communication device 11. The setting module 101 further can send the corresponding effect relating to each of the target features. The sender 2 can receive all the target features and the corresponding effect relating to each of the target features from the setting module 101 through the second communication device 21. The sender 2 further can display all the target features and the corresponding effect relating to each of the target features for a user of the sender 2. Thus, the user of the sender 2 can select the at least one target feature and the corresponding effect through the input device 24. The sender 2 can transmit the at least one target feature and the corresponding effect to the server 1 through the second communication device 21, thus, the setting module 101 can determine the at least one target feature and the corresponding effect when the server 1 receives the at least one target feature and the corresponding effect from the sender 2. For example, the at least one target feature can be one spoken word and the corresponding effect can be the playing of the cartoon.

In other exemplary embodiments, the at least one target feature and the corresponding effect are default settings. For example, the at least one target feature and the corresponding effect can be preset when the media data processing system 10 is developed.

At block 302, the receiving module 102 can receive media data and the address list from the sender 2. The address list lists at least one receiver 3 for receiving media data that has been processed by the server 1. In at least one exemplary embodiment, the media data can be an audio file (e.g., a recording), a video file (e.g., a video file recorded by the sender 2), a voice stream (e.g., a recording of dialing a call), or a video stream. In at least one exemplary embodiment, the sender 2 can send the media data to the server 1 in the form of file streaming. When the receiving module 102 receives a predetermined number of the media data from the sender 2, the block 303 is executed immediately, and the receiving module 102 can continue to receive the media data.

Thus, the receiving module 102 does not need to obtain the entire media data before block 303 is executed.

At block 303, the detecting module 103 can immediately detect the at least one target feature in the media data received from the sender 2 once the media data is received by the receiving module 102. In at least one exemplary embodiment, the detecting module 103 can detect the at least one target feature by invoking the preset programs. As mentioned above, the preset programs can be the facial expression recognition program, the speech recognition program, or the object recognition program. For example, when the at least one target feature is the smiling face, the detecting module 103 can detect the smiling face by invoking the facial expression recognition program. In at least one exemplary embodiment, when more than one target features need to be detected (i.e., the setting module 101 determines more than one target features) and one of the more than one target features is detected in the media data by the detecting module 103, the processing module 104 is immediately triggered. The detecting module 103 continues to detect other target features of the more than one target features in the media data, when one of the other target features is detected by the detecting module 103, the processing module 104 is executed. Similarly to the above steps, the detecting module 103 can detect all of the one or more target features.

At block 304, when the at least one target feature is detected in the media data, the processing module 104 can acquire the corresponding effect relating to the at least one target feature. The processing module 104 can apply the corresponding effect to the media data, thus processed media data is obtained. In at least one exemplary embodiment, the processing module 104 can apply the corresponding effect to the media data using a predetermined program. The predetermined program can be a video renderer.

At block 305, the processing module 104 can send the processed media data to the at least one receiver 3 according to the address list. In least one exemplary embodiment, the processing module 104 can further control the playback device 34 of the receiver 3 to playback the processed media data. In other exemplary embodiments, when the receiver 3 receives the processed media data, the receiver 3 controls the playback device 34 to playback the processed media data.

Here giving a description of an exemplary use of the present disclosure. For example, when a user “A” and a user “B” is in a video call, the user “A” sets a pronunciation of “Hanabi” as the target feature, and sets a corresponding effect relating to the target feature as the generating of sound and sight of fireworks. When the user “A” plan to invite the user “B” to watch fireworks together, the user “A” can say “Hanabi”. When the processing module 104 detects the word “Hanabi” being spoken, the processing module 104 can generate the sound and sight of fireworks to a frame of the video call.

It should be emphasized that the above-described embodiments of the present disclosure, including any particular embodiments, are merely possible examples of implementations, set forth for a clear understanding of the principles of the disclosure.

Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for processing media data in a server, the server is in communication with a sender, the method comprising:
determining at least one target feature and determining corresponding effect relating to the at least one target feature;
receiving media data from the sender;
detecting the at least one target feature in the media data; and
applying the corresponding effect relating to the at least one target feature to the media data in response to the at least one target feature being detected, thereby a processed media data is obtained.

2. The method according to claim 1, further comprising:
receiving an address list from the sender, wherein the address list lists one or more receivers for receiving the processed media; and
sending the processed media data to the one or more receivers according to the address list.

3. The method according to claim 1, wherein the determining of the at least one target feature and the determining of the corresponding effect relating to the at least one target feature comprises:
sending all of target features generally comprised in media data and the corresponding effect relating to each of the target features to the sender, wherein the sender determines the at least one target feature and the corresponding effect relating to the at least one target feature in response to user input; and
receiving the at least one target feature and the corresponding effect relating to the at least one target feature from the sender.

4. The method according to claim 1, wherein the at least one target feature comprises a predetermined facial expression, a predetermined action, a predetermined sound, and a predetermined object.

5. The method according to claim 1, wherein the corresponding effect relating to the at least one target feature comprises playing of a preset audio file, displaying of one or more predetermined pictures, playing of a predetermined cartoon, and presenting of one or more special effects.

6. A server comprising:
at least one processor; and
a storage device storing one or more programs, wherein when the one or more programs are executed by the at least one processor, the at least one processor is configured to:
determine at least one target feature and determine corresponding effect relating to the at least one target feature;
receive media data from a sender in communication with the server;
detect the at least one target feature in the media data; and
apply the corresponding effect relating to the at least one target feature to the media data in response to the at least one target feature is detected, thereby a processed media data is obtained.

7. The server according to claim 6, wherein the at least one processor is further configured to:
receive an address list from the sender, wherein the address list lists one or more receivers for receiving the processed media; and
send the processed media data to the one or more receivers according to the address list.

8. The server according to claim 6, wherein the determining of the at least one target feature and the determining of the corresponding effect relating to the at least one target feature comprises:
sending all of target features generally comprised in media data and the corresponding effect relating to each of the target features to the sender, wherein the sender determines the at least one target feature and the corresponding effect relating to the at least one target feature in response to user input; and
receiving the at least one target feature and the corresponding effect relating to the at least one target feature from the sender.

9. The server according to claim 6, wherein the at least one target feature comprises a predetermined facial expression, a predetermined action, a predetermined sound, and a predetermined object.

10. The server according to claim 6, wherein the corresponding effect relating to the at least one target feature comprises playing of a preset audio file, displaying of one or more predetermined pictures, playing of a predetermined cartoon, and presenting of one or more special effects.

11. A non-transitory storage medium having instructions stored thereon, when the instructions are executed by a processor of a server, the processor is configured to perform a method for processing media data, wherein the method comprises:
determining at least one target feature and determining corresponding effect relating to the at least one target feature;
receiving media data from a sender in communication with the server;
detecting the at least one target feature in the media data; and
applying the corresponding effect relating to the at least one target feature to the media data in response to the at least one target feature is detected, thereby a processed media data is obtained.

12. The non-transitory storage medium according to claim 11, wherein the method further comprises:
receiving an address list from the sender, wherein the address list lists one or more receivers for receiving the processed media; and
sending the processed media data to the one or more receivers according to the address list.

13. The non-transitory storage medium according to claim 11, wherein the determining of the at least one target feature and the determining of the corresponding effect relating to the at least one target feature comprises:
sending all of target features generally comprised in media data and the corresponding effect relating to each of the target features to the sender, wherein the sender determines the at least one target feature and the corresponding effect relating to the at least one target feature in response to user input; and
receiving the at least one target feature and the corresponding effect relating to the at least one target feature from the sender.

14. The non-transitory storage medium according to claim 11, wherein the at least one target feature comprises a predetermined facial expression, a predetermined action, a predetermined sound, and a predetermined object.

15. The non-transitory storage medium according to claim 11, wherein the corresponding effect relating to the at least one target feature comprises playing of a preset audio file, displaying of one or more predetermined pictures, playing of a predetermined cartoon, and presenting of one or more special effects.
